(19) United States
(12) Patent Application Publication
(10) Pub. No.: US 2025/0047166 A1
(43) Pub. Date: Feb. 6, 2025

(54) DRIVE UNIT FOR AN ON-VEHICLE PROTECTION DEVICE IN A VEHICLE INTERIOR

(71) Applicant: BOS GmbH & Co. KG, Ostfildern (DE)

(72) Inventors: Thomas SCHNEIDER, Esslingen (DE); Jörg MEYER, Stuttgart (DE); Max VON LÜTTICHAU, Ruit (DE)

(21) Appl. No.: 18/788,500

(22) Filed: Jul. 30, 2024

(30) Foreign Application Priority Data
Jul. 31, 2023 (DE) 10 2023 120 306.1

(51) Int. Cl. H02K 5/22; H02K 5/08; H02K 5/24

(52) U.S. Cl. CPC H02K 5/225; H02K 5/08; H02K 5/24

(57) ABSTRACT

Drive unit for a protection device in a vehicle interior, having an electric motor and control electronics for the electric motor arranged on a printed circuit board. The electric motor and the printed circuit board with the control electronics are incorporated into a common plastics casing. The plastics casing is constructed from a plurality of casing parts, connected together without the use of tools, and the control electronics arranged on the printed circuit board are arranged in the plastics casing adjacent to the electric motor.

### CROSS-REFERENCE TO RELATED APPLICATION

This claims priority from German Application No. 10 2023 120 306.1, filed Jul. 31, 2023, the disclosure of which is hereby incorporated by reference in its entirety.

### TECHNICAL FIELD

The invention relates to a drive unit for an on-vehicle protection device, in particular in a vehicle interior, having an electric motor and having control electronics for the electric motor which are arranged on a printed circuit board.

### BACKGROUND AND SUMMARY

Drive units of this type are generally known for winding shafts of shading devices for vehicle openings in a vehicle interior of a motor vehicle. The control electronics are arranged separately from the electric motor. The electric motor may be arranged fixedly on the vehicle and coaxially or radially offset relative to the winding shaft.

DE 10 2011 007 298 A1 discloses a motor/gear unit combination for a roller blind system for a vehicle interior, which motor/gear unit combination has an electric motor. The electric motor is flange-mounted externally to a gear casing of multipart construction.

One object of the invention is to provide a drive unit of the above-mentioned type which enables a compact structure and ease of handling.

This is achieved in that the electric motor and the printed circuit board having the control electronics are incorporated into a common plastics casing, in that the casing is constructed from a plurality of casing parts, connected together in particular toollessly, and in that the control electronics arranged on the printed circuit board are arranged in the casing adjacent to the electric motor. The solution is suitable both for drive units which are provided to drive at least one winding shaft of a protection device in a vehicle interior and for drive units which are provided to drive drive transmission lines such as helix cables or Bowden cable systems. The protection devices take the form of shading devices for side or rear windows or for transparent roof areas of interiors of motor vehicles or other vehicles. Alternative protection devices are luggage compartment cover devices or luggage compartment partitioning devices for motor vehicles which have covering or partitioning structures which can be deployed roughly horizontally or roughly vertically in the region of the luggage compartment. Seatbelt presenters in vehicle interiors also serve as protection devices for the purposes of the invention. Finally, it is also possible to provide the solution, according to one aspect of the invention, for applications external to vehicles, such as in particular covers for electrical plug-in connectors for charging an on-vehicle battery for a propulsion drive. According to one aspect of the invention, both the electric motor and the printed circuit board with the control electronics are fully housed in the plastics casing. The plastics casing is of multipart construction, consisting of at least two joined-together casing parts. The casing parts are connected such that on the one hand the casing parts form a casing unit of plastics handleable in the assembled, operational state, and on the other hand the casing parts terminate flush against one another. The plastics casing formed in this way has cavities into which the electric motor and the printed circuit board with the control electronics are incorporated.

In one configuration of the invention, the printed circuit board is positioned to the rear of the electric motor and oriented in a radial plane relative to a drive axis of rotation of the electric motor in the plastics casing. This results in a relatively short structural length for the drive unit along the drive axis of rotation of the electric motor. The orientation of the printed circuit board orthogonally to and to the rear of the electric motor, i.e. on the side opposite the output side of the electric motor, enables direct and compact attachment of the electric motor to an adjacent functional component such as in particular a gear unit.

In a further configuration of the invention, the casing has a substantially hollow cylindrical motor casing part, a printed circuit board casing part adjoining the motor casing part and a cover part closing the printed circuit board casing part at the rear. The casing is accordingly of three-part configuration.

In a further configuration of the invention, the casing is L-shaped, wherein, when the drive unit is in the assembled, operational state, one leg of the L is roughly horizontally oriented and the other leg of the L roughly vertically oriented. The L shape of the casing is based on viewing the drive unit from the side.

In a further configuration of the invention, the electric motor is arranged in the horizontally oriented leg of the L and the printed circuit board is arranged in the vertically oriented leg of the L, and the horizontally oriented leg of the L encloses at the front end the output side of the drive axis of rotation of the electric motor, and the vertically oriented leg of the L encloses the printed circuit board with the control electronics arranged to the rear of the electric motor. This results in a drive unit which is easy to handle and of compact construction.

In a further configuration of the invention, an opening is provided on one side in the vertical leg of the L, in particular on the front side, for flush accommodation of a plug connection part which is arranged on the printed circuit board and connected electrically with the control electronics. The plug connection part in the opening enables simple access from the outside to achieve a plug connection. The opening may be open in a downward direction or to the rear, side or front, depending on which side access is most advantageous with regard to installation criteria. If the opening in the vertical leg of the L is at the front, this enables plug connection from the front of the vertical leg of the L. This ensures particularly good accessibility for installing or uninstalling a corresponding plug connector.

In a further configuration of the invention, latching profiles are molded on the casing parts, which latching profiles have mutually complementary configurations such that adjacent casing parts are connected together using the complementary latching profiles. The latching profiles may be capable or incapable of being undone. In both cases they ensure toolless interconnection of the casing parts simply by fitting and latching the adjacent casing parts together.

In a further configuration of the invention, the latched connections produced by the latching profiles are made to be capable of being undone. This makes disassembly possible, if need be after completed assembly, in particular to replace the electric motor or the control electronics.

In a further configuration of the invention, the electric motor has an output shaft, which defines the drive axis of rotation and projects out of the electric motor to the front and rear, and the printed circuit board has a passage coaxial with the drive axis of rotation of the electric motor, the clear cross-section of which preferably corresponds at least to one diameter of the output shaft. In this way, when the electric motor is in the assembled, operational state in the plastics casing, axial rear support of the output shaft is ensured on axially setting a functional component in place, such that any axial pressure exerted from the front due to mounting of the functional component reliably does not bring about axial rearward displacement of the output shaft. Functional components that may in particular be provided are a pinion, a gear worm or other gear component to which the drive force of the electric motor is to be transmitted.

In a further configuration of the invention, the casing parts are provided with peripheral seals at their connection regions to the respective other casing parts, in order to achieve sealing of the casing when joined together. Depending on the design of the seals, tightness according to IP ratings IP61 to IP69 is possible.

In a further configuration of the invention, the seals are molded in one piece onto the casing parts. In this case, the casing parts are preferably produced using the multicomponent injection molding method, wherein an appropriate soft, elastic component forms the seals and a dimensionally stable plastics component ensures dimensionally stable construction of the casing parts.

In a further configuration of the invention, the electric motor is suspended in acoustically damped manner in the casing. This enables low-noise operation of the drive unit.

In a further configuration of the invention, elastically yielding damping rings are provided in the casing to the front and rear of the electric motor and coaxially with the drive axis of rotation. The damping rings may be produced as separate functional parts and inserted into the casing. Alternatively or in addition, at least one damping ring may be configured in one piece in a portion of a casing part adjacent an end face of the electric motor. Like the above-described seals, this damping ring is also made from an elastically yielding plastics material which is configured in one piece with the corresponding casing part in the multicomponent injection molding method.

In a further configuration of the invention, the casing part is produced as a two-component injection molding consisting of two plastics materials, one component of which constitutes an elastomer material and forms the damping ring. The term elastomer material should be understood to mean pure elastomers, produced synthetically or naturally, and also thermoplastic elastomers. In the case of molded-on seals of the casing part, the material for the damping ring may preferably be identical to the material for the seals. For the casing parts themselves, a dimensionally stable, thermoplastic plastics material is provided.

In a further configuration of the invention, at least one casing part is provided on the inside with support profiles which interact with complementary mating profiles on the end face of the electric motor for torque support of the electric motor relative to the casing. This enables particularly secure hold of the electric motor within the plastics casing, without the electric motor having to be fixed in the plastics casing by additional fastening elements. The mating profiles of the electric motor are preferably provided on an end face of a motor casing of the electric motor.

In a further configuration of the invention, at least one casing part has an adapter disk molded in one piece externally on an output side of the drive axis of rotation of the electric motor, which adapter disk is configured for torque support of the casing against a functional component adjacent the output side. In this way, the casing itself is simply supported such that torques generated by the electric motor and transmitted to the casing are supported by way of the adapter disk against the stationary functional component. To this end, the adapter disk is preferably rotationally asymmetrical relative to the drive axis of rotation. When mounted, the adapter disk is secured interlockingly to the corresponding adjacent functional component.

### BRIEF DESCRIPTION OF THE DRAWINGS

Further advantages and features are revealed by the following description of a preferred exemplary embodiment of the invention, which is explained with reference to the drawings, in which:

FIG. 1 is a perspective representation of one embodiment of a drive unit according to the invention;

FIG. 2 shows the drive unit according to FIG. 1 from another perspective;

FIG. 3 is an enlarged representation of a longitudinal section through the drive unit according to FIGS. 1 and 2 along a vertical median longitudinal plane in which lies a drive axis of rotation of an electric motor of the drive unit;

FIG. 4 shows a further longitudinal section along a horizontal median longitudinal plane, containing the drive axis of rotation, through the drive unit according to FIGS. 1 and 2;

FIG. 5 is a perspective exploded representation of the drive unit according to FIGS. 1 to 4;

FIG. 6 is a further exploded representation of the drive unit according to FIGS. 1 to 5 from another perspective;

FIG. 7 shows a casing part of the drive unit according to FIGS. 1 to 6 from a first perspective;

FIG. 8 shows the casing part according to FIG. 7 but from another perspective;

FIG. 9 is a front view of the casing part according to FIGS. 7 and 8; and

FIG. 10 is a sectional representation through the casing part according to FIG. 9, along section line X-X in FIG. 9.

### DETAILED DESCRIPTION

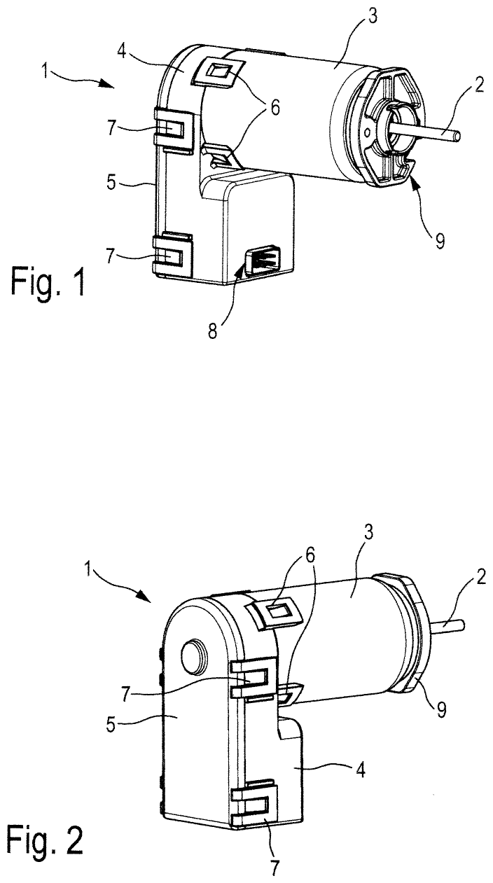

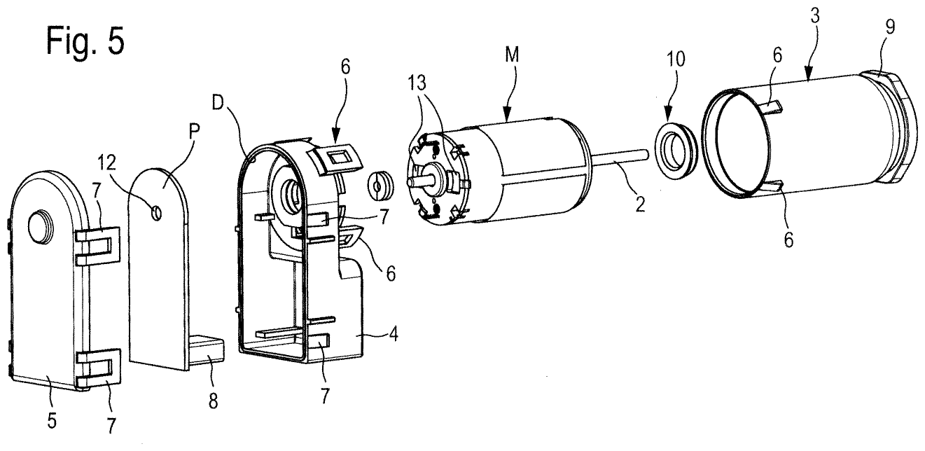

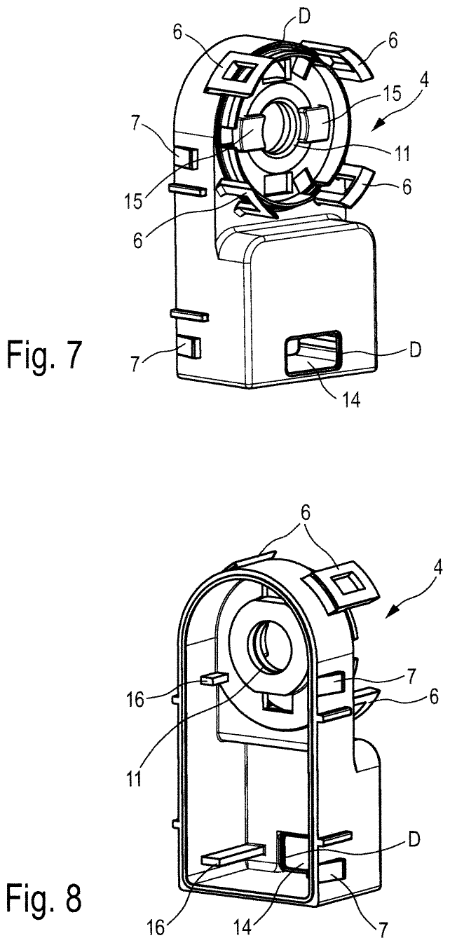

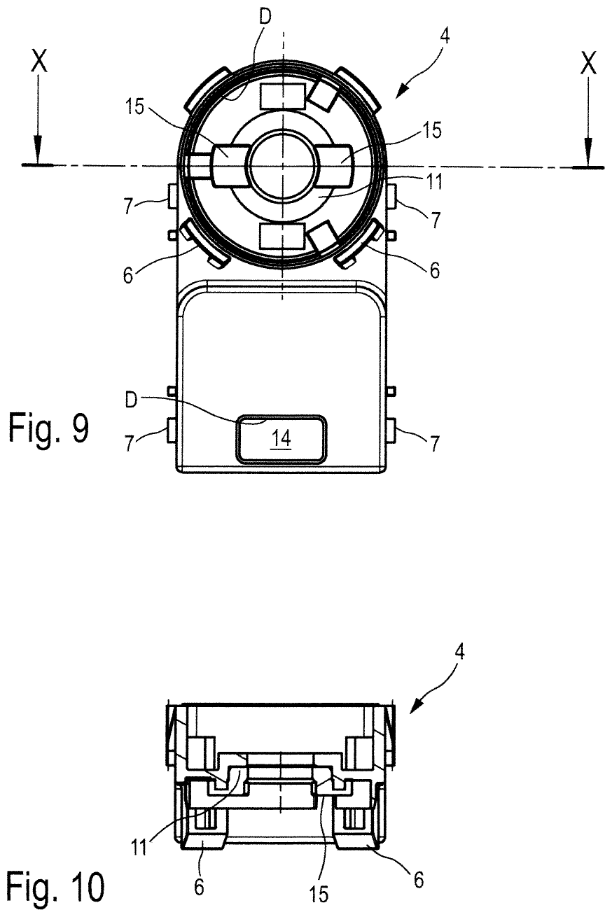

A drive unit 1 according to FIGS. 1 to 10 is provided for the electrical drive of a shading device for a side window of a passenger vehicle. The drive unit 1 here serves to drive a flexible shading structure, which is held in web form on a winding shaft so as to be windable on and off the latter. Using the drive unit 1, the roller blind web is displaced within the passenger compartment between a resting position and a shading position covering the side window. The drive unit 1 may either be associated directly with the winding shaft of the roller blind web via a suitable gear unit, in order to drive said web, or the drive unit 1 serves in electrical drive of a drive transmission system, having helix cables or a Bowden cable system. Both the helix cables and the Bowden cable system are installed in corresponding lateral guides fixed to the vehicle and move a pull-out profile connected to the shading web. This necessarily results in the desired displacement of the shading web between the resting position and the shading position.

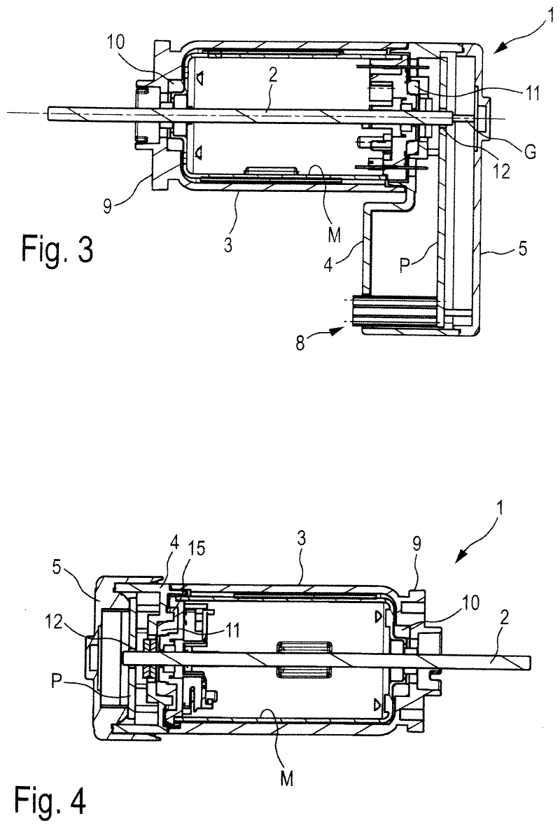

Drive unit 1 has an electric motor M, which is provided with an output shaft 2 extending through a motor casing of the motor M and defines a drive axis of rotation. Corresponding electrical drive components which drive the output shaft 2 when supplied with current are incorporated in a fundamentally known manner into the motor casing. The output shaft 2 projects both to the front (shown on the right in FIGS. 1 and 2) and to the rear out of the ends of the motor casing, as can be readily seen in FIGS. 3 to 5. The electric motor M is controlled by control electronics accommodated on a printed circuit board P. Both the electric motor M and the printed circuit board P with the control electronics are incorporated into a plastics casing, described in detail with reference to FIGS. 1 to 10. The plastics casing consists of three casing parts, namely a motor casing part 3, a printed circuit board casing part 4 and a cover part 5, which made mutually independently of plastics and assembled as a structural unit to form the plastics casing.

The motor casing part 3 is of substantially hollow-cylindrical embodiment and serves to accommodate the electric motor M fully in the motor casing part 3. In this way, the electric motor M is suspended at the end in the motor casing part 3 by way of a first, elastically yielding damping ring 10 of an elastomer material. The motor casing part 3 also has at its front end face an adapter disk 9, which is molded in one piece to the motor casing part 3. The adapter disk 9 coaxially surrounds the output shaft 2. The adapter disk 9 is rotationally asymmetrical and serves in non-rotatable fixing to an adjacent stationary functional component, in particular a gear casing. The adapter disk 9 thus forms a torque support for the motor casing part 3.

At the rear, the motor casing part 3 is closed by the printed circuit board casing part 4, which brings about rear support and securing of the electric motor M at a rear end face of the electric motor M. A rear end face of the motor casing of the electric motor M has, offset radially relative to the drive axis of rotation, two recesses 13 acting as mating profiles, into which complementary support profiles 15 of the printed circuit board casing part 4 project axially and in rotationally locked manner relative to the motor casing of the electric motor M. The support profiles 15 and the recesses 13 serve in torque support for the motor casing of the electric motor M relative to the plastics casing, i.e. relative to the motor casing part 3 and to the printed circuit board casing part 4.

The printed circuit board casing part 4 has a further damping ring 11, which is made from elastic material and supports the motor casing of the electric motor M in acoustically damping manner at the rear end face thereof. This damping ring 11 is formed in one piece on the printed circuit board casing part 4, wherein the printed circuit board casing part 4 is embodied as a two-component injection molding. The damping ring 11 and the support profiles 15 are made from the elastically yielding, acoustically damping plastics material, whereas a dimensionally stable casing shell of the printed circuit board casing part 4 is made from a thermoplastic plastics material. By using a two-component injection molding method for production purposes, the damping ring 11, the support profiles 15 and the dimensionally stable casing shell of the printed circuit board casing 4 form a one-piece component, wherein the elastic plastics material and the dimensionally stable, thermoplastic plastics material are bonded together. The printed circuit board casing part 4 serves on the one hand as a rear end closure for the motor casing part 3. On the other hand, the printed circuit board casing part 4 serves at its rear to accommodate and support the printed circuit board P provided with the control electronics. The control electronics are not shown in the drawings for reasons of clarity.

The motor casing part 3 and the printed circuit board casing part 4 have mutually complementary latching profiles 6, which, when the two casing parts are joined together, form an interlocking latching connection, which is capable of being undone in this case, between the two casing parts. The latching profiles 6 are molded in one piece on the printed circuit board casing part 4 on the one hand and on the motor casing part 3 on the other.

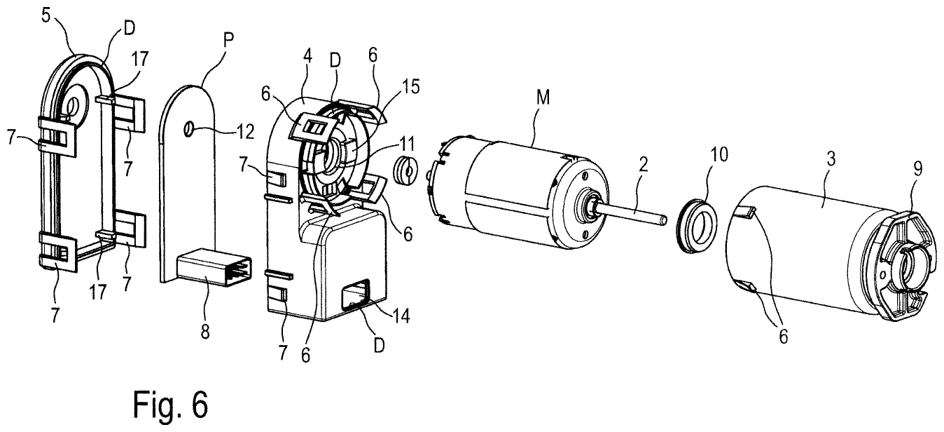

It is apparent from FIG. 6 that the end-face closure region of the printed circuit board casing part 4 is provided, relative to the hollow-cylindrical motor casing part 3, on the one hand with circular arc-shaped centering projections and on the other hand with a peripheral elastic seal D, which is likewise formed in one piece in the printed circuit board casing part 4 by the two-component injection molding method. The printed circuit board casing 4 may be plugged using this connection region flush and tightly onto the open end face of the motor casing part 3, so simultaneously also achieving rear end-face fixing and acoustically damping suspension of the electric motor M.

It is apparent from FIGS. 1 to 3 that the drive unit 1 is of substantially L-shaped construction when in the assembled, operational state. In this case, a leg of an L, in the representation according to FIGS. 1 to 3 the horizontal leg of an L, is formed by the hollow-cylindrical motor casing part 3, and the vertical leg of the L is formed by the printed circuit board casing part 4, which can be closed at the rear by a cover part 5.

The printed circuit board casing part 4 has a box-shaped receiving portion radially below its connecting region (relative to the drive axis of rotation of the electric motor M), which is provided at the front with a substantially rectangular opening 14. The opening 14 serves to receive a plug connection part 8, which is arranged on the front of the printed circuit board P and connected electrically with the electronic control components of the printed circuit board P. The plug connection part 8 has a rectangular cross-section, which corresponds roughly to the cross-section of the opening 14. In this way, the plug connection part 8 can be inserted from the back into the opening 14, such that a plug receptacle of the plug connection part 8 projects from the front of the box-shaped casing region of the printed circuit board casing part 4 into the opening 14 (FIG. 1). A peripheral edge of the opening 14 is provided with an elastic seal D, which is likewise formed in one piece in the printed circuit board casing part 4. The seals D, the damping ring 11 and the support profiles 15 of the printed circuit board casing part 4 may be made from the same elastic material, preferably an elastomer or a thermoplastic elastomer, and incorporated in one piece into the printed circuit board casing part 4 in the two-component injection molding method.

As is apparent from FIG. 8, the printed circuit board casing part 4, which is open at the rear, has support projections 16 molded on in one piece in the open interior thereof, which support projections serve in axial positioning of the printed circuit board P in the printed circuit board casing part 4. The rear of the printed circuit board casing part 4 is closable by the cover part 5, which can be set in place flush on the rear of the printed circuit board casing part 4 and interlockingly connectable with the printed circuit board casing part 4 in the flush-positioned state with the aid of latching profiles 7. The cover part 5 and the printed circuit board casing part 4 each have, at opposing side regions, two mutually complementary latching profiles 7 spaced vertically relative to one another, which are formed by latching lugs on the printed circuit board casing part 4 on the one hand and by latching hooks on the cover part 5 on the other. The cover part 5 has, on its end face facing the printed circuit board casing part 4, on the one hand a peripheral centering projection and on the other hand a peripheral seal D, which is made from an elastic material and, in the exemplary embodiment shown, is formed in one piece on the cover part 5. The cover part D additionally has support projections 17 similar to the support projections 16, which support projections 17 press the printed circuit board P from the rear axially against the support projections 16 and thus against the printed circuit board casing part 6, resulting in secure positioning for the printed circuit board P between the cover part 5 and the printed circuit board casing part 4.

It is clear from FIGS. 3 to 6 that the printed circuit board P has, at the level of the output shaft 2 and coaxially therewith, a passage 12 through which the rear end region of the output shaft 2 projects axially when the drive unit 1 is in the assembled state. This makes it possible to plug a functional component such as a pinion, a worm or similar component axially onto the output shaft 2 at the front and at the same time to apply an axial support moment from the rear onto the output shaft 2 even when the drive unit 1 is in the assembled, operational state. It is clear from FIG. 3 that a corresponding axial mating support element G may be mounted inside the cover part 5, such that axial support of the rear end face of the output shaft 2 is already necessarily achieved with setting and latching in place of the cover part 5, such that, when the drive unit 1 is in the assembled, operational state, a functional component can be plugged on axially at the front without the output shaft 2 being able to give way axially in a rearward direction.

The peripheral seal D on the inside of the cover part 5 ensures tight closure with the rear edge region of the printed circuit board casing part 4, such that the printed circuit board P is accommodated in watertight manner with its electronic control components in the plastics casing. Depending on the design of the seals D, tightness values in the range of IP ratings IP61 to IP69 are achievable.

In the exemplary embodiment according to FIGS. 1 to 10, the plastics casing housing the electric motor M and the printed circuit board P, with its three casing parts, namely the motor casing part 3, the printed circuit board casing part 4 and the cover part 5, is made to be capable of being undone. To this end, the corresponding latching hooks of the latching profiles 6 and 7, which engage interlockingly over the latching lugs, molded on in one piece, of the latching profiles 6 and 7 are embodied to be slightly elastically widenable, such that if need be, the cover part 5 can be removed again from the rear of the printed circuit board casing part 4 and the motor casing part 3 can be removed again from the front of the printed circuit board casing part 4. This makes it easy to replace the electric motor M and/or the printed circuit board P.

1. A drive unit for an on-vehicle protection device in a vehicle interior, the drive unit comprising:
an electric motor;
a printed circuit board; and
control electronics for the electric motor arranged on the printed circuit board, the electric motor and the printed circuit board with the control electronics being incorporated into a common plastics casing, the plastics casing being constructed from a plurality of casing parts, the casing parts being connected together, the control electronics being arranged on the printed circuit board in the plastics casing adjacent to the electric motor.

2. The drive unit as claimed in claim 1, wherein the printed circuit board is positioned to a rear of the electric motor and oriented in a radial plane relative to a drive axis of rotation of the electric motor in the plastics casing.

3. The drive unit as claimed in claim 1, wherein the plastics casing has a substantially hollow cylindrical motor casing part, a printed circuit board casing part adjoining the motor casing part and a cover part closing the printed circuit board casing part at a rear thereof.

4. The drive unit as claimed in claim 1, wherein the plastics casing is L-shaped and has first and second legs, and when the drive unit is in an assembled, operational state, the first leg of the L-shaped plastics casing is substantially horizontally oriented and the second leg of the L-shaped plastics casing is substantially vertically oriented.

5. The drive unit as claimed in claim 4, wherein the electric motor is arranged in the first leg of the plastics casing and the printed circuit board with the control electronics is arranged in the second leg of the plastics casing, and the first leg encloses at a front end an output side of the drive axis of rotation of the electric motor, and the second leg of the plastics casing encloses the printed circuit board with the control electronics arranged at a rear of the electric motor.

6. The drive unit as claimed in claim 4, further including a plug connection part arranged on the printed circuit board and connected electrically with the control electronics, and an opening disposed on one side of the second leg of the plastics casing for flush accommodation of the plug connection part.

7. The drive unit as claimed in claim 1, further including latching profiles molded on the casing parts, the latching profiles having mutually complementary configurations such that adjacent ones of the casing parts are connected together using the latching profiles.

8. The drive unit as claimed in claim 7, wherein the mutually complementary configurations of the latching profiles are configured for permitting detachment of the adjacent ones of the casing parts from one another.

9. The drive unit as claimed in claim 1, wherein the electric motor has a front, a rear and an output shaft, the output shaft defining a drive axis of rotation and projecting out of the electric motor to the front and rear, and the printed circuit board has a passage coaxial with the drive axis of rotation of the electric motor.

10. The drive unit as claimed in claim 1, wherein the casing parts include peripheral seals at respective connection regions with the respective other casing parts, in order to achieve tightness of the plastics casing when the casing parts are joined together.

11. The drive unit as claimed in claim 10, wherein the seals are molded in one piece with the casing parts.

12. The drive unit as claimed in claim 1, wherein the electric motor is suspended in an acoustically damped manner in the plastics casing.

13. The drive unit as claimed in claim 12, wherein the electric motor has a front, a rear and a drive axis of rotation, and the drive unit further includes elastically yielding damping rings disposed are provide in the plastics casing to the front and the rear of the electric motor and coaxially with the drive axis of rotation.

14. The drive unit as claimed in claim 13, wherein at least one damping ring is configured in one piece in a portion of one of the plurality of casing parts flanking an end face of the electric motor.

15. The drive unit as claimed in claim 14, wherein the one casing part comprises a two-component injection molding comprising two plastics materials, one component of the two-component injection molding comprising an elastomer material and forming the damping ring.

16. The drive unit as claimed in claim 1, wherein the electric motor has an end face including mating profiles, at least one of the plurality of casing part comprises, on an inside, support profiles, the support profiles interacting with the mating profiles on the end face of the electric motor for torque support of the electric motor relative to the plastics casing, and the mating profiles are configured to be complementary with the support profiles.

17. The drive unit as claimed in claim 1, wherein the electric motor has a drive axis of rotation and at least one of the plurality of casing parts has an adapter disk molded in one piece externally on an output side of the drive axis of rotation of the electric motor, the adapter disk being configured for torque support of the plastics casing against a functional component adjacent the output side.

18. The drive unit as claimed in claim 1, wherein the casing parts are connected together without the use of tools.

19. The drive unit as claimed in claim 6, wherein the one side of the second leg of the plastics casing is a front side.

20. The drive unit as claimed in claim 9, wherein the passage of the printed circuit board has a cross-section of a size substantially corresponding to at least one diameter of the output shaft of the electric motor.
